(19) United States
(12) Patent Application Publication
(10) Pub. No.: US 2026/0206667 A1
(43) Pub. Date: Jul. 23, 2026

(54) An Auxiliary Point Device, A Soil Working Tool And Agricultural Implement Comprising Such, A Mounting Device, An Auxiliary Point, A Method Of Modifying And Operating An Agricultural Implement

(71) Applicant: Väderstad Holding AB, Väderstad (SE)

(72) Inventors: Erik Wågbrant, Skänninge (SE); Magnus Samuelsson, Mullsjö (SE)

(21) Appl. No.: 19/140,658

(22) PCT Filed: Dec. 18, 2023
(86) PCT No.: PCT/EP2023/086359

§ 371 Date: Jun. 18, 2025

(30) Foreign Application Priority Data
Dec. 19, 2022 (SE) 2251491-3

(51) Int. Cl. A01B 63/00; A01B 61/04; A01B 63/24

(52) U.S. Cl. CPC A01B 63/008; A01B 61/046; A01B 63/24

(57) ABSTRACT

The document relates to an auxiliary point device (1) for a soil working tool (10) of an agricultural implement (100), comprising: a mounting device (2), configured for mounting to the soil working tool (10), and a point (3), movably mounted to the mounting device (2), said point (3) being movable between at least two different positions relative to the mounting device (2). The document further relates to a soil working tool (10) and an agricultural implement (100) comprising such auxiliary point device (1). The document further relates to a mounting device (2) for mounting a point (3) to a soil working tool (10), an auxiliary point (3) as well as a method of modifying an agricultural implement and a method of operating an agricultural implement.

### TECHNICAL FIELD

The present document relates to an auxiliary point device for a soil working tool of an agricultural implement. The present document also relates to a soil working tool and an agricultural implement comprising such auxiliary point device. The present document further relates to a mounting device for mounting a point to a soil working tool, an auxiliary point as well as a method of modifying an agricultural implement and a method of operating an agricultural implement.

### BACKGROUND

In order to accomplish effective soil working it is known to use double cultivating means. For example, SE 535 188 C2 discloses use of a front cultivator point arranged to process the soil down to a normal working depth and a rear cultivator point arranged to process the soil down to an increased working depth. SE 535 188 C2 further discloses a tine, wherein the front cultivator point is connected to the front side of the tine by means of a screw joint and wherein the rear cultivator point is mounted behind the first cultivator point in a screw joint. By such an arrangement, it is possible to combine different types of cultivator points at the front and rear position in order to achieve effective soil working with good result.

However, the changing of points is time-consuming. This is in particular disadvantageous when the soil conditions vary. Furthermore, having a tine with a point for working deep, also referred to as deep loosening, attached thereto increases the fuel consumption as compared with soil working at a shallower working depth.

Hence, it is desirable to provide an improved tool that allows for efficient deep loosening, even in varying conditions, and with reduced fuel consumption. Furthermore, it is desirable that the tool has good soil seeking properties and is capable of breaking up compacted soil while not drawing up raw soil to the surface.

### SUMMARY

It is an object of the present disclosure, to provide an improved soil working tool which eliminates or alleviates at least some of the disadvantages of the prior art.

More specific objects include providing a soil working tool that has good soil seeking properties, is capable of breaking up compacted soil efficiently while not drawing up raw soil to the surface, and that allows for efficient deep loosening.

The invention is defined by the appended independent claims. Embodiments are set forth in the appended dependent claims and in the following description and drawings.

According to a first aspect, there is provided an auxiliary point device for a soil working tool of an agricultural implement, comprising: a mounting device, configured for mounting to the soil working tool; and a point, movably mounted to the mounting device, said point being movable between at least two different positions relative to the mounting device.

The auxiliary point device is suitable as an add-on to a soil working tool such as a harrow tool or a cultivator tool, e.g. harrow tine, harrow shank, cultivator tine or cultivator shank. Such a soil working tool can be seen to comprise a first point or tip. The first point is preferably a soil-seeking point. The first point may for example be a common cultivator point or any other suitable type of point. Thus, the first point can be seen as a main point of the soil working tool.

Said point of the auxiliary point device can be seen as an auxiliary point or an add-on point, i.e. a second point of the soil working tool when mounted thereto. The point of the auxiliary point device may be a soil-seeking point. The point of the auxiliary point device may have a shape that differs from the first point of the soil working tool. Further, the point of the auxiliary point device can be formed in such a way that it only breaks the soil without mixing it with superjacent layers of soil. The point of the auxiliary point device can be formed for providing optimal draining of the soil. The point of the auxiliary point device can be formed for allowing optimal moisture and/or oxygen transport in the soil. Thus, the point of the auxiliary point device can be adapted to work at a greater depth than the first point of the soil working tool. The point of the auxiliary point device may be releasably mounted, such that it can be exchanged when worn.

A point body may, as seen in a projection on a vertical plane that is perpendicular to the working direction, be designed as a substantially rectangular shape with a main extent in the vertical direction. A lowermost part of the point may have a horizontally extending edge, which may extend over about 50-100% of a width of the point. Optionally, as seen in the vertical plane, the point may taper in the downward direction.

The point body may have a maximum width that is smaller than the maximum width of the soil working tool to which it is attached.

In use, the first point of the soil working tool may also serve the purpose of protecting the point of the auxiliary point device from wear.

The mounting device can be adapted to mount said point of the auxiliary point device at a rear side of the soil working tool, i.e. behind the first point of the soil working tool as seen in a working direction of the soil working tool in use. Further, the mounting device can be adapted to enclose at least a portion of said point of the auxiliary point device. Said point may be movable along a length direction of the mounting device.

The auxiliary point device may be mounted to a body of the soil working tool. Hence, the point may be movable along a tool body, which may be curved.

When the point of the auxiliary point device is movably mounted to the mounting device, the point can be raised and/or lowered relative the ground as seen in use. The movable mounting allows adjustment of the point between at least two different positions relative to the mounting device, e.g. between a working position and a non-working position and/or between different positions corresponding to different working depth settings. Thus, the movable mounting may allow for different settings of working depth of said point of the auxiliary point device. The movable mounting may also allow adjustment of the point into different positions during operation of the soil working tool. Thereby it is possible to adapt a single tine or a group of tines to work at a greater depth as compared with another tine or group of tines. Thus, it is possible to deep loosening the soil in selected areas, i.e. locally, for example in headland or in wheel or driving tracks. By only deep loosening in selected areas, it is possible to reduce fuel consumption.

The point of the auxiliary point device may be slidable along the mounting device. The point may be slidable along a direction which is in a vertical plane that contains the operating direction. In particular, this direction may be vertical +/−45 degrees, preferably +/−30 degrees.

The point of the auxiliary point device may be movable between a working position and a non-working position. The mounting device may comprise means for locking the point of the auxiliary point device in said working position. Alternatively or additionally, the mounting device may comprise means for locking the point of the auxiliary point device in said non-working position. For example, an actuator, locking pin or connector member may be used to lock the point in the desired position.

The point may be movable between at least a first position and a second position, wherein the first position corresponds to a first working depth setting of point and the second position corresponds to a second working depth setting of the point.

The auxiliary point device may further comprise an actuator operable between the mounting device and the point to control a movement of the point relative to the mounting device.

The actuator may for example be a cylinder actuator.

The actuator may be configured to manually and/or automatically control a movement of the point of the auxiliary point device. For example, the actuator may be configured to move the point between said working position and non-working position. Additionally, or alternatively, the actuator may be configured to move the point between said at least a first position and a second position.

Further, a controller may be used to control the actuator to adjust the position of the point.

The mounting device may comprise at least one slide slot.

The at least one slide slot may be straight or curved. The at least one slide slot may be seen to extend along a length direction of the mounting device. The at least one slide slot may extend between a first end and a second end. The first end may correspond to a working position of the point of the auxiliary point device. The second end may correspond to a non-working position of the point of the auxiliary point device.

The actuator may be arranged to move the point along said at least one slide slot of the mounting device.

The auxiliary point device may further comprise a first connection member.

The first connection member may be adapted for connecting the point of the auxiliary pointe device to the mounting device. For example, the first connection member may be adapted for connecting the point of the auxiliary point device to said at least one slide slot. Further, the first connection member may be configured for guiding said point along said at least one slide slot. Hence, the first connection member can be seen to form a point guide of the auxiliary point device.

Further, the connection member may be adapted to connect the point of the auxiliary point device and said actuator. Hence, the first connection member may be adapted to connect the point, said at least one slide slot of the mounting device, and the actuator of the auxiliary point device.

The first connection member may have a cylindrical shape. The first connection member may for example be provided in form a guide, a pin, or an axle.

The mounting device may comprise a first wall portion and a second, opposite wall portion.

A first inner surface of the first wall portion may face a second, inner surface of the second wall portion. A space adapted for accommodating at least a portion of said point, preferably a major portion of the point or the whole point may be formed between said first and second inner surface. Said space may be adapted for accommodating at least 50%, preferably at least 60% or 70 %, more preferably at least 80% or 90% of the point. Thus, when in the non-working position, said space may accommodate the point such that only a minor portion of the point, such as a first end portion or a tip of the point, protrude from an opening at a first end of the mounting device.

Said first and second wall portions may present a forwardly concave shape. Said forwardly concave shape can be adapted to follow a shape of the soil working tool. I.e. the forwardly concave shape may substantially correspond to a shape of a tine body.

The first wall portion may comprise a first slide slot and the second wall portion may comprise a second slide slot.

The first and second wall portions may extend between a first end and a second, opposite end of the mounting device, wherein the first end may present an opening through which said point is extendable and retractable.

Thus, the point may be mounted from below. I.e. the mounting of the point to said mounting device may include introducing the point of the auxiliary point device through said opening at the first end of the mounting device.

Further, at least one counter element may be arranged at a first end portion of the mounting device, wherein the at least one counter element may be arranged for supporting the point and/or directing the point into a desired position.

The desired position may for example be a working position, a non-working position or a position corresponding to a specific working depth. The desired position may also include a specific angle of the point in relation to the soil.

The at least one counter element may serve the purpose to ensure that the point of auxiliary point device are set into desired position and/or maintains the desired position during soil working. The at least one counter element may limit a forward and/or backward movement of the point of the auxiliary point device as seen in the working direction of the soil working tool in use. Thus, the at least one counter element may be configured to prevent the point from moving forward/backward in relation to the mounting device when in use.

In use, the first end portion can be seen to be arranged closer to the ground than a second, opposite end portion of the mounting device. The first end portion can be seen to comprise the first end of the mounting device.

Thus, the at least one counter element may be arranged adjacent said opening through which said point is extendable and retractable.

The mounting device may be seen to comprise a first counter element. Such first counter element can be seen to comprise a first support surface facing said space adapted for accommodating at least a portion of said point. The point of the auxiliary point device may be arranged such to abut on said first support surface, when the point is movably mounted to said mounting device. More particularly, a front surface of the point may be adapted to abut on said first support surface of the first counter element. Thus, the first counter element may be seen as a front counter element of the mounting device. The first counter element may limit a forward movement of the point of the auxiliary point device as seen in relation to the mounting device, and as seen in the working direction of the soil working tool in use. The first counter element may be provided in form of a screw or bolt.

The first counter element may be seen to provide a safety function in the sense of enabling to maintain the desired position of the point in the event that a traction vehicle would reverse with the point contacting the soil.

Additionally, or alternatively, the mounting device can be seen to comprise a second counter element. Such second counter element can be seen to comprise a support surface facing said space adapted for accommodating at least a portion of said point. The point of the auxiliary point device may be arranged such to abut on said support surface when the point is movably mounted to said mounting device. More particularly, a rear surface of the point may be adapted to abut on said support surface of the second counter element. Thus, the second counter element may be seen as a rear counter element of the mounting device. The second counter element may limit a rearward movement of the point of the auxiliary point device as seen in relation to the mounting device, and as seen in the working direction of the soil working tool in use. The second counter element may serve the purpose of supporting the point of the auxiliary point device in use, such that the point can maintain the desired position.

Consequently, the point may be sandwiched between said first and second counter element, when movably mounted to said mounting device.

The point of the auxiliary point device may comprise a first end portion adapted for soil working and a second, opposite end portion presenting an attachment portion for movable mounting to the mounting device.

Said actuator may be connected to said attachment portion.

According to a second aspect, there is provided a soil working tool for an agricultural implement, comprising a tine body, wherein an auxiliary point device according to the first aspect as described above is mounted to said soil working tool.

The soil working tool may be a cultivator tool or a harrow tool, e.g. a harrow tine, a harrow shank, a cultivator tine or a cultivator shank.

The auxiliary point device may be mounted to a rearwardly facing side of the soil working tool.

The soil working tool may further comprise a first point mounted to said tine body.

The first point may be seen as a main point of the soil working tool.

The first point may be mounted to a first end portion of said tine body. A second, opposite end portion of said tine body may be adapted for connection to an agricultural implement.

The first point can be fixedly mounted to the tine body. Fixedly mounted means that the first point is not movable relative to the tine body while it is mounted. However, fixedly mounted does not exclude that the first point may be releasably mounted, such that it can be exchanged when worn.

The first point may be arranged for working at a first working depth, and the point of the auxiliary point device may be arranged for working at a second working depth being greater than the first working depth of the first point.

The point of the auxiliary point device may be arranged for working at a second working depth being 0 -140 mm greater than a first working depth of the first point, preferably 1-10 mm, 10-20 mm, 20-30 mm, 30-40 mm, 40-50 mm, 50-60 mm, 60-70 mm, 70-80 mm, 80-90 mm, 90-100 mm, 100-110, 110-120 mm, 120-130 mm, or 130-140 mm greater than a first working depth of the first point.

According to a third aspect, there is provided an agricultural implement comprising a plurality of soil working tools, wherein each soil working tool comprises a tine body, and wherein an auxiliary point device according to the first aspect as described above, is mounted to at least one of the plurality of soil working tools, preferably to a subset of the plurality of soil working tools, in particular a subset which correspond laterally to at least one wheel of the agricultural implement and/or of a traction vehicle.

Hence, a single soil working tool, a plurality of the soil working tools or all of the soil working tools of the agricultural implement may have an auxiliary point device, as described in relation to the first aspect, mounted thereto.

The agricultural implement may be a cultivator or a tine harrow. The traction vehicle may be a tractor.

At least one soil working tool of the agricultural implement, preferably a subset of the soil working tools, arranged at a lateral position corresponding to at least one wheel of the agricultural implement or a traction vehicle, may be provided with said auxiliary point device.

Thus, it is possible to deep loosening the soil locally in wheel or driving tracks.

The agricultural implement may further comprise at least one actuator arranged for moving at least one point of at least one auxiliary point device.

For example, an actuator may be arranged to move a single point of an auxiliary point device, a plurality of points, e.g. a group of points of a plurality of auxiliary point devices, or the points of all auxiliary point devices.

As one alternative, a plurality of actuators may be provided. Each one of said plurality of actuators may be arranged to move a single point or a plurality of points, e.g. a group of points of a plurality of auxiliary point devices. A group of points may for example include the points of all auxiliary point devices of a row of the agricultural implement.

The agricultural implement may further comprise a controller configured to control at least one actuator to adjust a position of at least one point of at least one auxiliary point device.

The controller may be configured to control at least one actuator such to adjust the position of a single point, a plurality of points, e.g. a group of points, or all of the points of the auxiliary point device(s).

For example, the at least one actuator may be controlled to move the at least one point between a working position and a non-working position.

Alternatively, or additionally, the at least one actuator may be controlled to move the at least one point between at least a first position and a second position, wherein the first position corresponds to a first working depth setting of said point and the second position corresponds to a second working depth setting of said point.

The controller may be configured to control the at least one actuator to adjust the position of the at least one point based on location data and/or a soil condition data.

The location data may be GPS coordinates of the agricultural implement. The soil condition data may be a predicted soil condition value and/or a measured soil condition value of the soil. For example, the soil condition data may be a predicted value of the degree of compaction of the soil, or a measured value of the degree of compaction of the soil.

According to a fourth aspect there is provided a mounting device for mounting a point behind a soil working tool, wherein the mounting device is configured for mounting to the soil working tool, and wherein the mounting device comprises a mounting portion for movable mounting of the point to the mounting device.

The mounting portion may comprise a continuous adjustment portion, such as at least one slide slot, for movable mounting of the point to the mounting device.

As one alternative, the mounting portion may comprise at least two fixed portions, such as at least two holes for discretely selective mounting of the point to the mounting device. Said at least two holes corresponding to different positions of the point relative the mounting device.

As yet another alternative, the mounting portion may comprise at least one joint for pivotable mounting of the point to the mounting device.

The mounting device may comprise a first wall portion and a second, opposite wall portion.

A first inner surface of the first wall portion may face a second, inner surface of the second wall portion. A space adapted for accommodating at least a portion of the point, preferably a major portion of the point or the whole point may be formed between said first and second inner surface.

Said first and second wall portions may present a forwardly concave shape.

According to a fifth aspect, there is provided soil working tool for an agricultural implement, comprising a tine body, wherein a mounting device as described in relation to the fourth aspect is mounted to said soil working tool. The soil working tool may be a cultivator tool or a harrow tool, e.g. a harrow tine, a harrow shank, a cultivator tine or a cultivator shank.

According to a sixth aspect, there is provided an auxiliary point for mounting behind a soil working tool of an agricultural implement, wherein the point comprises a first end portion adapted for soil working and a second, opposite end portion presenting an attachment portion configured for movable mounting to a mounting device configured for mounting to the soil working tool.

The point may comprise a point body comprising said first end portion adapted for soil working, a first mounting tongue joined to a first side of the point body, and a second mounting tongue joined to a second, opposite side of the point body.

Thus, a portion of the point body can be seen to be arranged intermediate the first and second mounting tongues.

The first and second mounting tongues can be seen to comprise said attachment portion configured for movable mounting to a mounting device.

The attachment portion may present at least one aperture adapted for receiving a first connection member for movably mounting the point to said mounting device.

The at least one aperture may be provided in form of a through hole.

According to a seventh aspect, there is provided a method of modifying an agricultural implement, the method comprising providing an agricultural implement having at least one soil working tool and providing an auxiliary point device comprising a mounting device, configured for mounting to the soil working tool, and a point, movably mounted to the mounting device, said point being movable between at least two different positions relative to the mounting device. The method further comprising mounting the mounting device to a rearwardly facing side of the soil working tool, such that when the point is in a first one of the positions, a lowermost portion of the point is at a vertical level below a lowermost portion of the soil working tool, and when the point is in a second one of the positions, the lowermost portion of the point is at a vertical level equal to or above the lowermost portion of the soil working tool.

According to an eight aspect, there is provided a method of operating an agricultural implement, the method comprising providing an agricultural implement having at least one soil working tool and at least one auxiliary point device, mounted at a rearwardly facing side of the soil working tool. The auxiliary point device comprising a mounting device configured for mounting to the soil working tool, and a point, movably mounted to the mounting device, said point being movable between at least two different positions relative to the mounting device. The method further comprising moving said point from a first one of said positions to a second one of said positions while the soil working tool is in engagement with soil to be worked.

The method may further comprise controlling the position of the point based on location data of the agricultural implement and/or soil condition data.

Thus, the method may comprise providing location data of the agricultural implement and/or soil condition data to a controller. The method may further comprise controlling at least one actuator to adjust a position of at least one point of at least one auxiliary point device based on said location data and/or soil condition data.

The method may comprise controlling the agricultural implement such to move a single point of an auxiliary point device, a group of points of a plurality of auxiliary point devices or all of the points of all auxiliary point devices of the agricultural implement.

### BRIEF DESCRIPTION OF THE DRAWINGS

Embodiments of the present solution will now be described, by way of example, with reference to the accompanying schematic drawings in which:

FIG. 1a is a schematic side view of a soil working tool with a point of an auxiliary point device in a working position.

FIG. 1b is a schematic side view of a soil working tool with a point of an auxiliary point device as illustrated in FIG. 1a, seen in a view without a first wall portion of a mounting device of the auxiliary point device.

FIG. 2a is a schematic side view of a soil working tool with a point of an auxiliary point device in a non-working position.

FIG. 2b is a schematic side view of a soil working tool with a point of an auxiliary point device as illustrated in FIG. 2a, seen in a view without a first wall portion of a mounting device of the auxiliary point device.

FIG. 3 is an exploded view of a soil working tool and an auxiliary point device.

FIG. 4 is a schematic view of an agricultural implement drawn by a traction vehicle.

FIG. 5 is a schematic side view of a soil working tool with an auxiliary point device according to another embodiment, wherein the point of the auxiliary point device is in a working position.

FIG. 6 is a schematic side view of a soil working tool with an auxiliary point device according to yet another embodiment, wherein the point of the auxiliary point device is in a working position.

### DESCRIPTION OF EMBODIMENTS

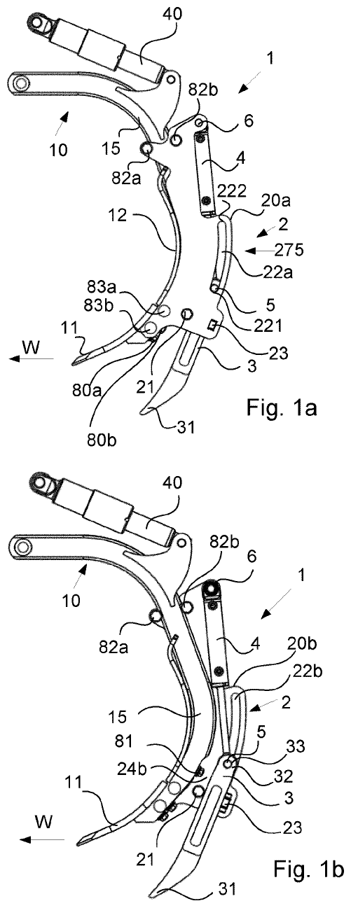

In relation to FIGS. 1-3, an auxiliary point device 1 will be described. The auxiliary point device 1 is adapted for mounting to a soil working tool 10 of an agricultural implement 100. More particularly, the auxiliary point device 1 can be mounted to a rearwardly facing side of a soil working tool 10.

The soil working tool may for example be a harrow tool or a cultivator tool, such as a harrow tine, a harrow shank, a cultivator tine, or a cultivator shank.

FIGS. 1-3 illustrates one example of a soil working tool 10. As illustrated in FIGS. 1-3, the soil working tool can be seen to comprise a tine body 15.

Further, the soil working tool can be seen to comprise a first point 11. The first point 11 is preferably designed as a soil-seeking point. The first point may for example be a common cultivator point as disclosed in the figures or any other suitable type of point. Thus, the first point 11 can be seen as a main point of the soil working tool 10.

As illustrated in FIGS. 1-3, the first point 11 may be mounted to a first end portion of said tine body 15. A second, opposite end portion of said tine body 15 may be adapted for connection to an agricultural implement.

The first point 11 can be fixedly mounted to the tine body 15. Thus, the first point 11 may not be movable relative to the tine body 15 while it is mounted. However, the first point 11 may be releasably mounted, such that it can be exchanged when worn. The first point 11 may be mounted to the tine body 15 by any suitable fixing member, such as for example at least one screw or bolt. As illustrated in FIGS. 1-3, the first point 11 may be fixedly mounted to the tine body 15 by means of fixing members 80a, 80b.

Further, as illustrated in FIGS. 1-3, the soil working tool 10 may comprise a guide plate 12 for guiding a soil flow, so as to achieve a desired effect, such as soil mixing. The guide plate 12 may be releasably mounted to the tine body 15, such that it can be exchanged when worn. The guide plate 12 may be mounted to the tine body 15 by any suitable fixing member, such as for example at least one screw or bolt. As illustrated in FIGS. 1b, 2b and 3, the guide plate 12 may be mounted to the tine body 15 by means of a fixing member 81.

Further, as illustrated in FIGS. 1-3, the soil working tool 10 may comprise a stone safety device comprising a hydraulic cylinder 40.

As illustrated in FIGS. 1-3, the auxiliary point device 1 comprises a mounting device 2 and a point 3.

The mounting device 2 is configured for mounting to the soil working tool 10. More specifically, the mounting device 2 can be adapted for mounting to a rearwardly facing side of the soil working tool 10, as illustrated in FIGS. 1-3. Thus, the mounting device 2 can be adapted to engage the tine body 15 from behind. Consequently, the mounting device 2 can be adapted to mount said point 3 of the auxiliary point device 1 at a rear side of the soil working tool 10, i.e. behind the first point 11 of the soil working tool 10 as seen in a working direction W of the soil working tool 10 in use.

The mounting device 2 may be fixedly mounted to the tine body 15 by any suitable fixing member, such as at least one screw or bolt. As illustrated in FIGS. 1-3, the mounting device may be fixedly mounted to the tine body 15 by means of a first fixing member 82a, a second fixing member 82b, a third fixing member 83a, and a fourth fixing member 83b.

The point 3 is movably mounted to the mounting device 2. Thus, the point is movable between at least two different positions relative to the mounting device 2.

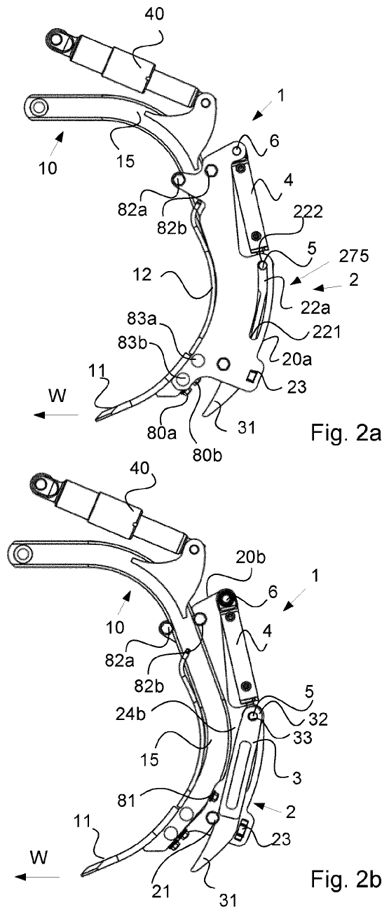

For example, the point 3 may be movable between a working position, as illustrated in FIGS. 1a-1b, and a non-working position, as illustrated in FIGS. 2a-2b. Additionally or alternatively, the point 3 may be movable between at least a first position and a second position. The first position can correspond to a first working depth setting of point 3. The second position can correspond to a second working depth setting of the point 3.

Thus, the point 3 may be movable between a plurality of different positions, such as for example a non-working position, a first working position corresponding to a first working depth setting of point 3, a second working position corresponding to a second working depth setting of point 3, a third working position corresponding to a third working depth setting of point 3 and/or a fourth working position corresponding to a fourth working depth setting of point 3.

The point 3 of the auxiliary point device 1 may be releasably mounted to the mounting device 2, such that it can be exchanged when worn.

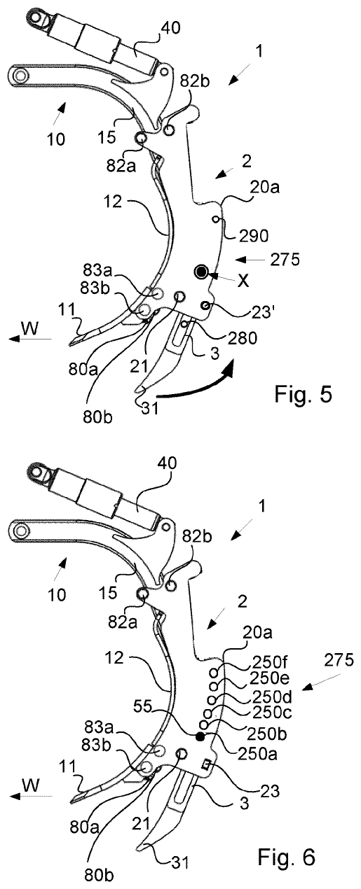

The mounting device 2 may comprise a mounting portion 275 for movable mounting of the point 3 to the mounting device 2, see for example FIG. 1a, FIG. 2a, FIG. 5 and FIG. 6.

The mounting portion may comprise a continuous adjustment portion, such as for example at least one slide slot 22a, 22b, for movable mounting of the point 3 to the mounting device 2, see FIGS. 1-3.

Thus, the point 3 may be slidable along the mounting device 2.

For example, the mounting device 2 may comprise at least one slide slot 22a, 22b, wherein the point 3 is slidable along said at least one slide slot. The at least one slide slot may be straight or curved. The at least one slide slot can be seen to extend along a length direction of the mounting device 2. The at least one slide slot may extend between a first end 221 and a second end 222 of said slide slot, see for example FIG. 1a and FIG. 2a.

As illustrated in FIGS. 1-3, the auxiliary point device 1 may further comprise a first connection member 5. The first connection member 5 may be arranged for connecting the point 3 of the auxiliary point device 1 to said at least one slide slot 22a, 22b. The first connection member 5 may be configured for guiding said point 3 along said at least one slide slot 22a, 22b. Thus, the first connection member 5 may be seen as a point guide. When the first connection member 5 is located at the first end 221 of said at least one slide slot 22a, 22b, the point 3 may be in a working position, see for example FIG. 1a. When the first connection member 5 is located at the second end 222 of said at least one slide slot 22a, 22b, the point 3 may be in a non-working position, see for example FIG. 2a.

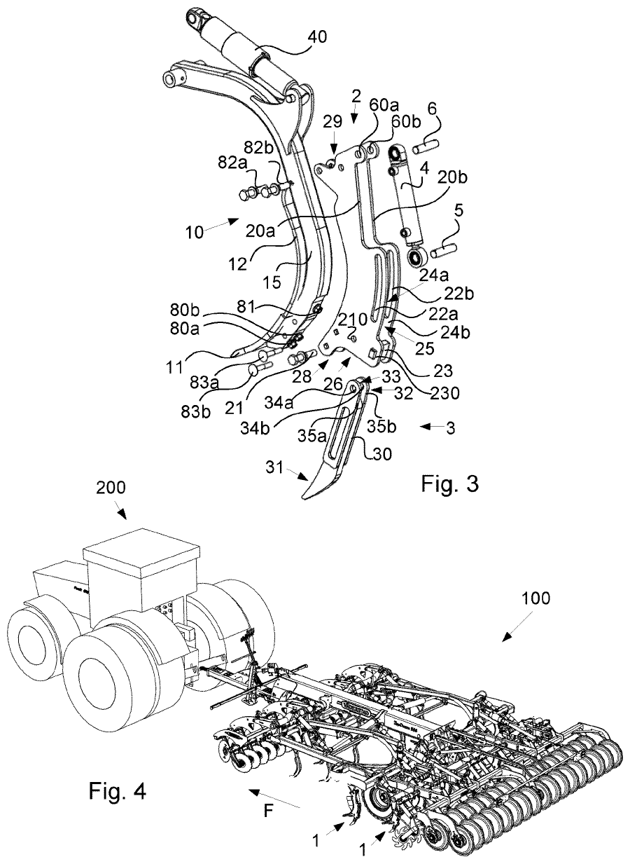

As illustrated in FIG. 3, the first connection member 5 may have a cylindrical shape. The first connection member 5 may for example be provided in the form of a bolt, a guide, a pin, or an axle.

Further, the mounting device 2 can be adapted to enclose at least a portion of said point 3, see FIG. 1a and FIG. 2a.

As illustrated in FIG. 3, the mounting device 2 may comprise a first wall portion 20a and a second, opposite wall portion 20b. The first and second wall portions 20a, 20b may be arranged such that a first inner surface 24a of the first wall portion 20 faces a second, inner surface 24b of the second wall portion 20b, thereby forming a space 25 between the inner surfaces 24a, 24b. The space 25 can be adapted for accommodating at least a portion of said point 3. Preferably the space 25 is adapted to accommodate a major portion of the point 3 or the whole point 3. Said space 25 may be adapted for accommodating at least 50%, preferably at least 60% or 70%, more preferably at least 80% or 90% of the point 3. Thus, when in the non-working position, said space 25 may accommodate the point 3 such that only a minor portion of the point, such as the first end portion 31 or a tip of the point, protrude from the opening 26 at a first end of the mounting device 2.

Consequently, when in the non-working position, less than 50%, preferably less than 40% or less than 30%, more preferably less than 20% or less than 10% of the point 3 may protrude from the mounting device 2.

Said first and second wall portions 20a, 20b may present a forwardly concave shape. Said forwardly concave shape can be adapted to follow a shape of the soil working tool 10. I.e. the forwardly concave shape may substantially correspond to a shape of the tine body 15, see for example FIG. 3.

Further, as illustrated in FIG. 3, the first wall portion 20a can comprise a first slide slot 22a. The second wall portion 20b can comprise a second slide slot 22b.

Further, as illustrated in FIG. 3, the first and second wall portions 20a, 20b can be seen to extend between a first end 28 and a second, opposite end 29 of the mounting device 2. The first end 28 may present an opening 26. The point 3 can extendable and retractable through said opening.

Further, the mounting device 2 may comprise at least one counter element 21, 23. The at least one counter element 21, 23 may be arranged at a first end portion of the mounting device 2. The at least one counter element 21, 23 may be arranged for supporting the point 3. Additionally, or alternatively, the at least one counter element 21, 23 may be arranged to direct the point 3 into a desired position.

As illustrated in FIGS. 1-3, the mounting device may be seen to comprise a first counter element 21. Such first counter element 21 can be seen to comprise a first support surface facing said space 25 adapted for accommodating at least a portion of said point 3. The point 3 of the auxiliary point device 1 may be arranged such to abut on said first support surface, when the point 3 is movably mounted to said mounting device 2. More particularly, a front surface of the point 3 may be adapted to abut on said first support surface of the first counter element 21, see FIG. 1b and FIG. 2b. Thus, the first counter element 21 may be seen as a front counter element of the mounting device 2. The first counter element may for example be provided in form of a screw or bolt.

Further, as also illustrated in FIGS. 1-3, the mounting device can be seen to comprise a second counter element 23. Such second counter element 23 can be seen to comprise a support surface facing said space 25 adapted for accommodating at least a portion of said point 3. The point 3 of the auxiliary point device 1 may be arranged such to abut on said support surface when the point 3 is movably mounted to said mounting device 2.

More particularly, a rear surface of the point 3 may be adapted to abut on said support surface of the second counter element 23, see FIG. 1b and FIG. 2b.

Thus, the second counter element 23 may be seen as a rear counter element of the mounting device 2.

Hence, the point 3 may be sandwiched between said first and second counter elements 21, 23, when movably mounted to said mounting device 2, see FIG. 1b and FIG. 2b.

The first and second counter elements 21, 23 can be seen to extend between the first and second wall portions 20a, 20b. The first counter element 21 may be attached to each one of the first and second wall portions 20a, 20b through engagement with an aperture 210 arranged in the first and second wall portions 20a, 20b respectively. The second counter element 23 may be attached to each one of the first and second wall portions 20a, 20b through engagement with an aperture 230 arranged in the first and second wall portions 20a, 20b respectively.

According to one embodiment, the first and/or second counter element 21, 23 may be provided as a shear pin or safety pin. Thus, the first and/or second counter element 21, 23 may be designed to break when subjected to a force greater than a predetermined threshold value.

The point 3 of the auxiliary point device 1 can be seen as an auxiliary point or an add-on point, i.e. a second point of the soil working tool 10 when mounted thereto. The point 3 of the auxiliary point device 1 may be a soil-seeking point. In particular the point 3 may be a point for working deep. As illustrated in FIGS. 1-3, the point 3 may have a shape that differ from the first point 11 of the soil working tool 10. A width of the point 3 may be smaller than a width of the first point 11. Further, the point 3 of the auxiliary point device 1 can be formed in such a way that it only breaks the soil without mixing it with superjacent layers of soil. The point 3 of the auxiliary point device 1 can be formed for providing optimal draining of the soil. The point 3 may be angled downwardly and forwardly, as seen when mounted to the mounting device 2. The point 3 may present an angle of up to 45° relative a vertical, preferably up to about 30°.

The point 3 of the auxiliary point device 1 can be adapted to work at a greater depth than the first point 11 of the soil working tool 10. For example, the point 3 of the auxiliary point device 1 may be adapted to work at a depth being approximately 0 -140 mm greater than the working depth of the first point 11 of the soil working tool 10. The point 3 of the auxiliary point device 1 may be adapted to work at a depth being approximately 1-10 mm, 10-20 mm, 20-30 mm, 30-40 mm, 40-50 mm, 50-60 mm, 60-70 mm, 70-80 mm, 80-90 mm, 90-100 mm, 100-110, 110-120 mm, 120-130 mm, or 130-140 mm greater than a first working depth of the first point 11.

As illustrated in FIGS. 1-3, the point 3 can comprise a first end portion 31 adapted for soil working. The end portion 31 may be formed of a hard material and/or present a wear-resistant coating or layer.

As also illustrated in FIGS. 1-3, the point 3 can comprise a second, opposite end portion 32. The second end portion 32 can present an attachment portion 33 configured for movable mounting to the mounting device 2. The attachment portion 33 may for example present at least one aperture 34a, 34b adapted to receive said first connection member 5.

Further, as illustrated in FIG. 3, the point 3 can comprise a point body 30. The point body 30 can be seen to comprise said first end portion 31 adapted for soil working. As also illustrated in FIG. 3, the point 3 may further comprise a first mounting tongue 35a joined to a first side of the point body 30. The point 3 may further comprise a second mounting tongue 35b joined to a second, opposite side of the point body 30. Thus, as illustrated in FIG. 3, a portion of the point body 30 can be seen to be arranged intermediate the first and second mounting tongues 35a, 35b. The first and second mounting tongues 35a, 35b can be seen to comprise said attachment portion 33. As illustrated in FIG. 3, the first mounting tongue 35a can comprise a first aperture 34a adapted to receive said first connection member 5. As also illustrated in FIG. 3, the second mounting tongue 35b can comprise a second aperture 34b adapted to receive said first connection member 5.

Further, as illustrated in FIGS. 1-3, the auxiliary point device 1 may comprise an actuator 4. The actuator 4 may be operable between the mounting device 2 and the point 3 to control a movement of the point 3 relative to the mounting device 2. The actuator 4 may for example be a cylinder actuator. The actuator 4 may be configured to manually and/or automatically control a movement of the point 3 of the auxiliary point device 1. For example, the actuator 4 may be configured to move the point 3 between a working position and a non-working position. Additionally, or alternatively, the actuator 4 may be configured to move the point 3 between at least a first position and a second position. The first position may correspond to a first working depth setting of point 3 and the second position may correspond to a second working depth setting of the point 3. Thus, it is understood that the actuator 4 may be configured to move the point 3 between a plurality of different positions, such as for example a non-working position, a first working position corresponding to a first working depth setting of point 3, a second working position corresponding to a second working depth setting of point 3, a third working position corresponding to a third working depth setting of point 3 and/or a fourth working position corresponding to a fourth working depth setting of point 3.

The actuator 4 may be arranged to move the point 3 along the at least one slide slot 22a, 22b of the mounting device 2, see FIGS. 1-3.

The actuator 4 may be connected to said attachment portion 33 of the point 3. As illustrated in FIGS. 1-3, the actuator 4 may be connected to said attachment portion 33 by means of said first connection member 5. Hence, the first connection member 5 may be adapted to connect the point 3, said at least one slide slot 22a, 22b of the mounting device 2, and the actuator 4.

As illustrated in FIGS. 1-3, the actuator 4 may be connected to the mounting device 2 by means of a second connection member 6. The second connection member 6 may have a cylindrical shape. The second connection member 6 may for example be provided in the form of a bolt, a guide, a pin, or an axle. The connection member 6 may be configured to engage at least one aperture 60a, 60b of the mounting device 2. As illustrated in FIG. 3, the first wall portion 20a of the mounting device 2 can comprise a first aperture 60a adapted to receive said connection member 6. As also illustrated in FIG. 3, the second wall portion 20b can comprise a second aperture 60b adapted to receive said connection member 6.

Further, a controller (not illustrated) may be used to control the actuator 4. The controller may be configured to control the actuator 4 to adjust the position of the point 3.

As described above, the point 3 of the auxiliary point device 1 may be releasably mounted to the mounting device 2, such that it can be exchanged when worn. Thus, when the point 3 is worn out, the point 3 can be released from said mounting device 2. The point 3 may be released by disengaging the connecting member 5. The point 3 may then be removed through said opening 26 of the mounting device 2. Another not-worn point 3 may then be mounted to the mounting device 2. The point 3 may be mounted from below. The mounting of the point 3 to said mounting device 2 may include introducing the point 3 of the auxiliary point device 1 through said opening 26 at the first end of the mounting device 2. The mounting of the point 3 to said mounting device 2 may further comprise positioning the point 3 in said space 25 formed between said first and second inner surfaces 24a, 24b of the first and second wall portions 20a, 20b of the mounting device 2. Further, the mounting of the point 3 to said mounting device 2 may comprise aligning the attachment portion 33 of the point 3 with said at least one slide slot 22a, 22b of the mounting device 2. Further, the mounting of the point 3 to said mounting device 2 may comprise bringing the connection member 5 into engagement with the attachment portion 33 of said point 3. Further, the mounting of the point 3 to said mounting device 2 may comprise connecting the point 3 with said actuator 4. Consequently, the mounting may comprise connecting the point 3, the at least one slide slot 22a, 22b and the actuator 4 by means of said connection member 5.

Although FIGS. 1-3 illustrate a mounting device 2 comprising a mounting portion 275 with a continuous adjustment portion for movable mounting of the point 3 to the mounting device 2, other configurations are possible. Thus, other configurations are possible, wherein the point 3 is movably mounted to the mounting device 2 such that said point 3 is movable between at least two different positions relative to the mounting device 2.

As one example, see FIG. 5, the point 3 of the auxiliary point device 1 may be pivotably connected to the mounting device 2. Thus, the mounting portion 275 may comprise at least one joint for pivotable mounting of the point 3 to the mounting device 2. Thus, the point 3 of the auxiliary point device 1 may be rotatable about an axis X such that it is moved between at least two different positions relative to the mounting device 2, for example between a working position and a non-working position. FIG. 5 illustrates the point 3 in a working position. For example, the point 3 of the auxiliary point device 1 could be rotated in an opposite direction of the working direction of the soil working tool, i.e. backwards away from the soil working tool 10, in order to bring the point into a non-working position. Before the rotation, the second counter element 23′can be removed from the mounting device 2 or moved into a position such that the point 3 is allowed to be moved backwards. Movement of the second counter element 23′could be performed manually or automatically. The second counter element 23′may for example be provided in form of a pin. The rotation of the point 3 could be performed manually or automatically. Thus, the auxiliary point device 1 could be configured for manual or automatically rotation of the point 3 such that the point 3 is moved between at least two different positions relative to the mounting device 2.

Automatic rotation could for example be achieved by means of a gear arrangement (not illustrated), such as an arrangement comprising a gear rack and a gear wheel, or by means of a link arrangement (not illustrated). Further, as illustrated in FIG. 5, the point 3 and the mounting device 2 may each be provided with interlocking members, such as corresponding holes 280, 290, which can be used to lock the point 3 in a non-working position. For example, the point could be rotated into an upward position and locked to the mounting device 2 by bringing a connection member (not illustrated), such as for example a bolt, a guide, a pin, or an axle, into engagement with said holes 280, 290. The point 3 may be designed essentially the same or differently as described above in relation to FIGS. 1-3. The mounting device 2 may be fixedly mounted to the tine body 15 of the soil working tool 10 in similar with what has been described in relation to FIGS. 1-3 above.

According to another example, the mounting portion 275 may comprise at least two fixed portions for discretely selective mounting of the point 3 to the mounting device 2. For example, the mounting device 2 of the auxiliary point device 1 could be provided with a plurality of holes corresponding to different position settings of the point, such as for example a non-working position, a first working position corresponding to a first working depth setting of the point, a second working position corresponding to a second working depth setting of the point, and/or a third working position corresponding to a third working depth setting of the point.

FIG. 6 illustrates one example, wherein the mounting device 2 comprises a plurality of holes 250a, 250b, 250c, 250d, 250e, 250f for mounting. The point 3 could be mounted to the mounting device 2 by bringing a locking pin 55 into engagement with a hole (not illustrated) of the point 3 and a hole of the mounting device 250a, 250b, 250c, 250d, 250e, 250f. In order to change the position of the point 3, the locking pin 55 could be disengaged, and instead be brought into engagement with another hole 250a, 250b, 250c, 250d, 250e, 250f of the mounting device 2 corresponding to a different position setting. Thus, the point 3 of the auxiliary point device 1 could be movable between at least two different positions relative to the mounting device 2 by manual adjustment. The point 3 may be designed essentially the same as described above in relation to FIGS. 1-3. As one alternative, the point 3 may be designed differently. For example, the point 3 may be provided with a plurality of holes (not illustrated) corresponding to different position settings of the point 3, such as for example a non-working position, a first working position corresponding to a first working depth setting of the point, a second working position corresponding to a second working depth setting of the point, and/or a third working position corresponding to a third working depth setting of the point. The mounting device 2 may be fixedly mounted to the tine body 15 of the soil working tool 10 in similar with what has been described in relation to FIGS. 1-3 above.

In relation to FIG. 4, an agricultural implement 100 will now be described. As illustrated in FIG. 4, the agricultural implement 100 may be drawn by a traction device 200, such as a tractor. The agricultural implement 100 can comprise a plurality of soil working tools 10. The soil working tools 10 may be designed and configured the same or essentially the same as described above in relation to FIGS. 1-3. Further, the agricultural implement 100 can comprise at least one auxiliary point device 1. The at least one auxiliary point device 1 may be designed and configured as described above in relation to FIGS. 1-3, FIG. 5 and/or FIG. 6.

Hence, a single soil working tool 10, a plurality of the soil working tools 10 or all of the soil working tools 10 of the agricultural implement 100 may have an auxiliary point device 1 as described in relation to FIGS. 1-3, FIG. 5 and/or FIG. 6.

FIG. 4 illustrates an agricultural implement 100 comprising a plurality of auxiliary point devices 1.

Consequently, the agricultural implement 100 may comprise a plurality of soil working tools 10, wherein each soil working tool 10 comprises a first point 11, and wherein at least one of the plurality of soil working tools 10 have a second point 3 movably mounted to the soil working tool 10 by means of a mounting device 2. The second point 3 can be seen to be arranged behind said first point 11, as seen in a direction of travel F of the agricultural implement 100, see FIG. 4.

The agricultural implement 100 may comprise a first group of soil working tools 10 without an auxiliary point device 1. The agricultural implement 100 may further comprise and a second group of soil working tools 10 with an auxiliary point device 1 mounted thereto.

As one example, the agricultural device 100 may comprise a group of soil working tools 10, i.e. a subset of said plurality of soil working tools 10, arranged at a lateral position corresponding to at least one wheel of the agricultural implement 100 or of the traction vehicle 200, which each are provided with an auxiliary point device 1, such as an auxiliary point device 1 described in relation to FIGS. 1-3, FIG. 5 and/or FIG. 6.

Further, the agricultural implement 100 may comprise at least one actuator arranged for moving at least one point 3 of at least one auxiliary point device 1. For example, an actuator 4 may be arranged to move a single point 3 of an auxiliary point device 1 as described above in relation to FIGS. 1-3. As an alternative, an actuator (not illustrated) may be arranged to move a plurality of points 3, e.g. a group of points 3 of a plurality of auxiliary point devices 1, or the points 3 of all auxiliary point devices 1. A group of points 3 may for example include the points 3 of all auxiliary point devices 1 of a row of the agricultural implement 100.

The agricultural implement 100 may further comprise a controller (not illustrated). The controller can be configured to control at least one actuator to adjust a position of at least one point 3 of at least one auxiliary point device 1. The controller may be configured to control at least one actuator such to adjust the position of a single point 3, a plurality of points 3, e.g. a group of points 3, or all of the points 3 of the auxiliary point device(s) 1.

For example, the at least one actuator may be controlled to move the at least one point 3 between a working position and a non-working position.

Alternatively, or additionally, the at least one actuator may be controlled to move the at least one point 3 between at least a first position and a second position. The first position may correspond to a first working depth setting of said point 3. The second position may correspond to a second working depth setting of said point 3. Thus, the at least one actuator may be controlled by the controller to move the at least one point 3 between a plurality of different positions, including a non-working position and/or at least one working position, preferably a plurality of different working positions. The plurality of different working positions corresponding to different working depth settings. Further, the controller (not illustrated) may be configured to control the at least one actuator to adjust the position of the at least one point 3 based on location data and/or a soil condition data. The location data may be GPS coordinates of the agricultural implement 100. The soil condition data may be a predicted soil condition value and/or a measured soil condition value of the soil. For example, the soil condition data may be a predicted value of the degree of compaction of the soil, or a measured value of the degree of compaction of the soil.

Thus, when in use, the points 3 of the auxiliary point devices 1 of the agricultural implement 100 may be automatically and/or manually adjusted to have substantially the same position, being a non-working position or a working position corresponding to a specific working depth setting.

As one alternative, the points 3 of the auxiliary point devices 1 of the agricultural implement 100 may be automatically and/or manually adjusted such that there are at least two points 3 having different positions as compared with one another.

As one example, every point 3 of a group of soil working tools 10 arranged at a lateral position corresponding to at least one wheel of the agricultural implement 100 or of the traction vehicle 200, may be set into a working position, while all the other points 3 of the auxiliary point devices 1 of the agricultural implement 100 may be set into a non-working position.

As yet another example, every other point 3 in a row may be set into substantially the same position as compared with one another, being a non-working Position or a working position corresponding to a specific working depth setting.

As yet another example, a first group of points 3 mounted to a first group of soil working tools 10 located on a first side of a central line of the agricultural implement 100 may be positioned to have a first working depth setting, and a second group of points 3 mounted to a second group of soil working tools 10 on a second, opposite side of the central line may be positioned to have a second working depth setting, different from the first working depth setting.

Further, the agricultural implement 100 may be configured such that all points 3 are automatically moved into a non-working position when the agricultural implement 100 is lifted for ground clearance. For example, the controller (not illustrated) may be configured to control the at least one actuator to move the at least one point 3 into a non-working position when the agricultural implement 100 is lifted for ground clearance.

A method of modifying an agricultural implement will now be described. The method comprises providing an agricultural implement 100 having at least one soil working tool 10, such as for example the agricultural implement described in relation to FIG. 4. The method further comprises providing an auxiliary point device 1, such as the auxiliary point device 1 described in relation to FIGS. 1-3, FIG. 5 and/or FIG. 6.

The method further comprises mounting the mounting device 2 of the auxiliary point device 1 to a rearwardly facing side of the soil working tool 10 such that when the point 3 is in a first one of the positions, a lowermost portion of the point is at a vertical level below a lowermost portion of the soil working tool 10, and when the point 3 is in a second one of the positions, the lowermost portion of the point 3 is at a vertical level equal to or above the lowermost portion of the soil working tool 10.

A method of operating an agricultural implement will now be described. The method comprises providing an agricultural implement 100 having at least one soil working tool 10 and at least one auxiliary point device 1 mounted at a rearwardly facing side of the soil working tool 10. The at least one soil working tool 10 may be designed and configured the same or essentially the same as described above in relation to FIGS. 1-3. The at least one auxiliary point device 1 may be designed and configured as described above in relation to FIGS. 1-3, FIG. 5 and/or FIG. 6. The method further comprises moving the point 3 from a first position to a second position while the soil working tool 10 is in engagement with soil to be worked.

The method may further comprise controlling the position of the point 3 based on location data of the agricultural implement 100. Additionally, or alternatively, the method may comprise controlling the position of the point 3 based on soil condition data. Thus, the method may comprise providing location data of the agricultural implement and/or soil condition data to a controller. The method may further comprise controlling at least one actuator to adjust a position of at least one point 3 of at least one auxiliary point device 1 based on said location data and/or soil condition data.

The method may comprise controlling the agricultural implement 100 such to move a single point 3 of an auxiliary point device 1, a group of points 3 of a plurality of auxiliary point devices 1, or all of the points 3 of all auxiliary point devices 1 of the agricultural implement 100. A group of points 3 may for example include the points 3 of all auxiliary point devices 1 of a row of the agricultural implement 100.

1-38. (canceled)

39. An auxiliary point device for a soil working tool of an agricultural implement, comprising:
a mounting device, configured for mounting to the soil working tool, and
a point, movably mounted to the mounting device,
said point being movable between at least two different positions relative to the mounting device,
wherein the mounting device comprises:
a first wall portion and a second, opposite wall portion,
wherein a first inner surface of the first wall portion faces a second, inner surface of the second wall portion, and
wherein a space adapted for accommodating at least a portion of said point is formed between said first and second inner surface.

40. The auxiliary point device according to claim 39, wherein the point is slidable along the mounting device.

41. The auxiliary point device according to claim 39, wherein the point is movable between at least a first position and a second position, wherein the first position corresponds to a first working depth setting of point and the second position corresponds to a second working depth setting of the point.

42. The auxiliary point device according to claim 39, further comprising an actuator operable between the mounting device and the point to control a movement of the point relative to the mounting device.

43. The auxiliary point device according to claim 39, wherein the space formed between said first and second inner surface is adapted for accommodating a major portion of the point or the whole point.

44. The auxiliary point device according to claim 39, wherein the first wall portion comprises a first slide slot and the second wall portion comprises a second slide slot.

45. The auxiliary point device according to claim 39, wherein the mounting device comprises at least one counter element extending between the first and second wall portions, wherein the at least one counter element is arranged for supporting the point and/or directing the point into a desired position.

46. The auxiliary point device according to claim 39, wherein the first wall portion comprises at least two holes for discretely selective mounting of the point to the mounting device, wherein said at least two holes corresponds to different positions of the point relative the mounting device.

47. The auxiliary point device according to claim 39, wherein the mounting device comprises a mounting portion for movable mounting of the point to the mounting device, wherein the mounting portion comprises at least one joint for pivotable mounting of the point to the mounting device.

48. A soil working tool for an agricultural implement, comprising:
a tine body,
wherein an auxiliary point device according to claim 39 is mounted to said soil working tool.

49. The soil working tool according to claim 48, further comprising a first point mounted to said tine body.

50. The soil working tool according to claim 49, wherein the first point is arranged for working at a first working depth, and the point of the auxiliary point device is arranged for working at a second working depth being greater than the first working depth of the first point.

51. An agricultural implement comprising a plurality of soil working tools, wherein each soil working tool comprises a tine body, and wherein an auxiliary point device according to claim 39 is mounted to at least one of the plurality of soil working tools.

52. The agricultural implement according to claim 51, further comprising at least one actuator arranged for moving at least one point of at least one auxiliary point device, and further comprising a controller configured to control at least one actuator to adjust a position of at least one point of at least one auxiliary point device, wherein the controller is configured to control the at least one actuator to adjust the position of the at least one point based on location data and/or a soil condition data.

53. A mounting device for movable mounting a point behind a soil working tool, wherein the mounting device is configured for mounting to the soil working tool, and wherein the mounting device comprises:
a first wall portion and a second, opposite wall portion,
wherein a first inner surface of the first wall portion faces a second, inner surface of the second wall portion, and
wherein a space adapted for accommodating at least a portion of the point is formed between said first and second inner surface.

54. A soil working tool for an agricultural implement, comprising:
a tine body,
wherein a mounting device according to claim 53 is mounted to said soil working tool.

55. A method of modifying an agricultural implement, comprising:
providing an agricultural implement having at least one soil working tool,
providing an auxiliary point device according to claim 39, and
mounting the mounting device to a rearwardly facing side of the soil working tool, such that:
when the point is in a first one of the positions, a lowermost portion of the point is at a vertical level below a lowermost portion of the soil working tool, and
when the point is in a second one of the positions, the lowermost portion of the point is at a vertical level equal to or above the lowermost portion of the soil working tool.

56. A method of operating an agricultural implement, comprising:
providing an agricultural implement having:
at least one soil working tool;
at least one auxiliary point device according to claim 39, mounted at a rearwardly facing side of the soil working tool,
wherein the method further comprising:
moving said point from a first one of said positions to a second one of said positions while the soil working tool is in engagement with soil to be worked.

57. The method according to claim 56, further comprising:
controlling the position of the point based on location data of the agricultural implement and/or soil condition data.

58. The method according to claim 56, comprising controlling the agricultural implement such to move a single point of an auxiliary point device, a group of points of a plurality of auxiliary point devices or all of the points of all auxiliary point devices of the agricultural implement.
